(19) United States
(12) Patent Application Publication
(10) Pub. No.: US 2018/0022394 A1
(43) Pub. Date: Jan. 25, 2018

(54) COMPOSITE STRUCTURES AND VEHICLE BODY COMPONENTS

(71) Applicant: FORD GLOBAL TECHNOLOGIES, LLC, Dearborn, MI (US)

(72) Inventor: Ari Garo CALISKAN, Canton, MI (US)

(21) Appl. No.: 15/213,847

(22) Filed: Jul. 19, 2016

(51) Int. Cl. B62D 29/00; B32B 15/08; B62D 27/02

(52) U.S. Cl. CPC B62D 29/005; B62D 27/02; B32B 15/08; B29C 45/1459

(57) ABSTRACT

A composite structure includes a metallic plate and a cured-plastic sheet. The metallic plate has and an external boundary and a centrally located offset protruding towards a first side. The metallic plate defines at least one aperture extending through a thickness of the metallic plate. The cured-plastic sheet is secured to the first side of the metallic plate. The cured-plastic sheet extends beyond the boundary and into the at least one aperture.

### TECHNICAL FIELD

The present disclosure relates to composite structures that may be utilized for constructing components for vehicle bodies or frames.

### BACKGROUND

Vehicle frames and bodies may comprise various components that are constructed from similar or dissimilar materials.

### SUMMARY

A vehicle body structural member includes a metallic disk, cured-plastic sheet, and metallic sheet. The metallic disk has an external perimeter and defines at least one aperture extending through a thickness of the metallic disk. The cured-plastic sheet is secured to the metallic disk. The cured-plastic sheet extends beyond the perimeter and into the at least one aperture. The metallic sheet is disposed on an opposing side of the cured-plastic sheet relative to the metallic disk and is secured to the metallic disk.

A composite structure includes a metallic plate and a cured-plastic sheet. The metallic plate has and an external boundary and a centrally located offset protruding towards a first side. The metallic plate defines at least one aperture extending through a thickness of the metallic plate. The cured-plastic sheet is secured to the first side of the metallic plate. The cured-plastic sheet extends beyond the boundary and into the at least one aperture.

A method includes inserting a metal plate that defines at least one aperture into a first side of a mold such that a first side of the metal plate contacts the mold while a second side of the metal plate remains exposed, placing an uncured-plastic material into contact with the second side of the metal plate such that the plastic material permeates the at least one aperture, and curing the plastic material.

### BRIEF DESCRIPTION OF THE DRAWINGS

FIG. 1A is a top view of a first embodiment of a metallic plate or disk;

FIG. 1B is a cross-sectional view taken along line 1B-1B in FIG. 1A;

FIG. 2A is a top view of a second embodiment of a metallic plate or disk;

FIG. 2B is a cross-sectional view taken along line 2B-2B in FIG. 2A;

FIG. 3A is a top view of a third embodiment of a metallic plate or disk;

FIG. 3B is a cross-sectional view taken along line 3B-3B in FIG. 3A;

FIG. 4 is a cross-sectional view illustrating a mold and components for forming a composite structure;

FIG. 5 is a cross-sectional view illustrating the composite structure formed in the mold;

FIG. 6A is a top view of a structural component that includes the composite structure formed in the mold;

FIG. 6B is a cross-sectional view taken along line 6B-6B in FIG. 6A; and

FIG. 7 is method of forming a composite structure.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

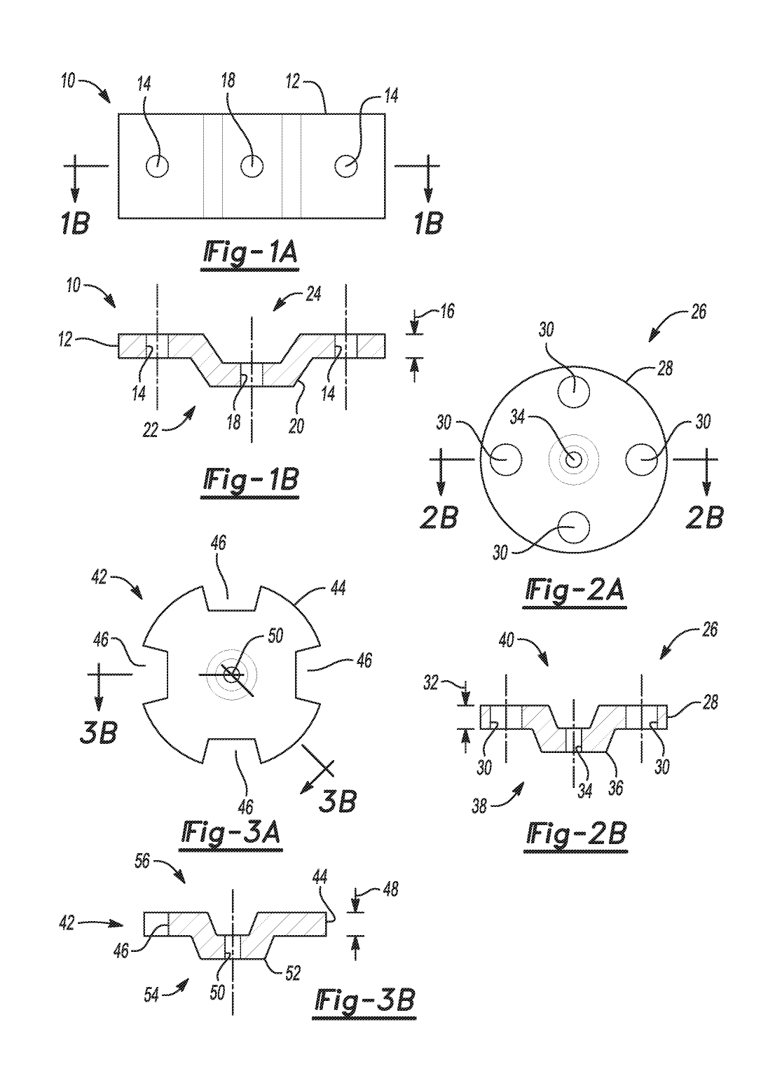

Referring to FIGS. 1A and 1B a first embodiment of a metallic plate (or disk) 10 is illustrated. The metallic plate 10 has an exterior perimeter (or external boundary) 12 when viewed from the top view. In the first embodiment, the exterior perimeter 12 has a rectangular shape. The metallic plate 10 defines at least one aperture 14 that extends through a thickness 16 of the metallic plate 10. The at least one aperture 14 may be a through or tapped hole(s). The at least one aperture 14 may comprise a plurality of through holes that are evenly spaced relative to the exterior perimeter 12 or a centrally located orifice 18. The metallic plate 10 may include a centrally located offset 20 that protrudes towards a first side 22 of the metallic plate 10, the first side 22 being opposite a second side 24 of the metallic plate 10. Alternatively, the first side 22 may be referred to as the second side while the second side 24 may be referred to as the first side. The metallic plate 10 may be secured to a plastic or composite material to form a composite structure or component.

Referring to FIGS. 2A and 2B a second embodiment of a metallic plate (or disk) 26 is illustrated. The metallic plate 26 has an exterior perimeter (or external boundary) 28 when viewed from the top view. In the second embodiment, the exterior perimeter 28 has a circular shape. The metallic plate 26 defines at least one aperture 30 that extends through a thickness 32 of the metallic plate 26. The at least one aperture 30 may be a through or tapped hole(s). The at least one aperture 30 may comprise a plurality of through holes that are evenly spaced relative to the exterior perimeter 28 or a centrally located orifice 34. The metallic plate 26 may include a centrally located offset 36 that protrudes towards a first side 38 of the metallic plate 10, the first side 38 being opposite a second side 40 of the metallic plate 26. Alternatively, the first side 38 may be referred to as the second side while the second side 40 may be referred to as the first side. The metallic plate 26 may be secured to a plastic or composite material to form a composite structure or component.

Referring to FIGS. 3A and 3B a third embodiment of a metallic plate (or disk) 42 is illustrated. The metallic plate 42 has an exterior perimeter (or external boundary) 44 when viewed from the top view. In the third embodiment, the exterior perimeter 44 has a partially circular shape that is interrupted by a series of cut-outs. The metallic plate 42 defines at least one aperture 46 that extends through a thickness 48 of the metallic plate 42. The at least one aperture 46 may be a cut-out(s) or notch(es) that interrupt the exterior perimeter 44. The at least one aperture 46 may comprise a plurality of notches that are evenly spaced relative to the exterior perimeter 44 or a centrally located orifice 50. The metallic plate 42 may include a centrally located offset 52 that protrudes towards a first side 54 of the metallic plate 42, the first side 54 being opposite a second side 56 of the metallic plate 42. Alternatively, the first side 54 may be referred to as the second side while the second side 56 may be referred to as the first side. The metallic plate 42 may be secured to a plastic or composite material to form a composite structure or component.

Although the three embodiments of the metallic plates 10, 26, and 42 have exterior perimeters that are shown to have distinct particular shapes from their respective top views. However, it should be understood that the exterior perimeters of the metallic plates 10, 26, and 42 may have any desirable shape. Furthermore, the one or more apertures defined by the metallic plates 10, 26, and 42 may be rearranged spatially to any desired configuration. The one or more apertures may also include any number of or combination of through holes, tapped holes, cut-outs, or notches. The metallic plate may be made from any desirable metallic material including steel, aluminum, titanium, magnesium, or any other appropriate metallic material.

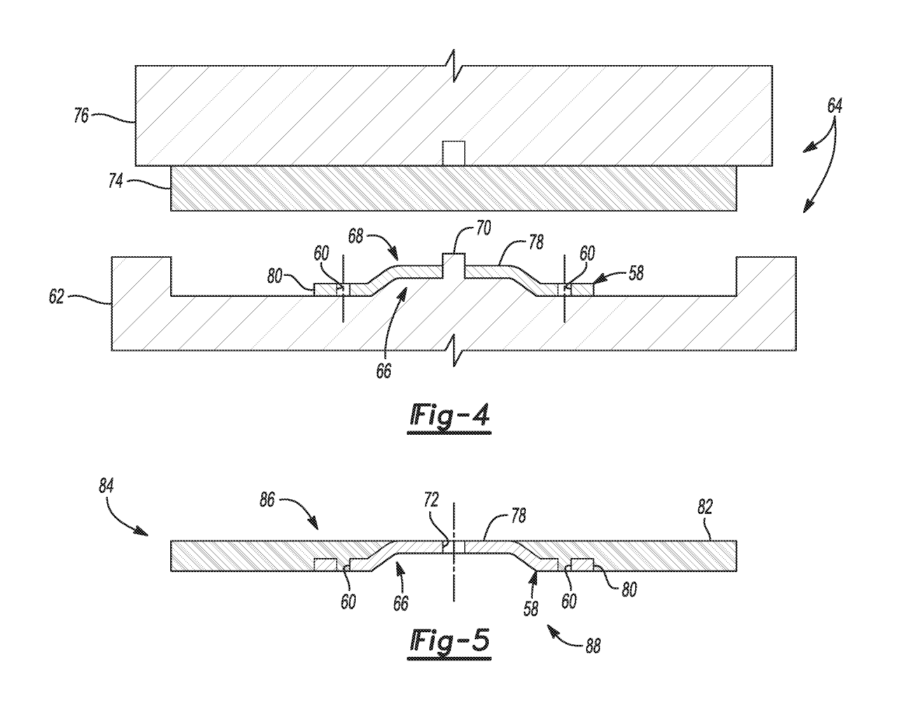

Referring to FIGS. 4 and 5, a mold, the components for forming a composite structure, and the composite structure formed in the mold are illustrated. A metallic plate (or disk) 58 that defines at least one aperture 60 is placed onto a first side 62 of a mold 64. A first side 66 of the metallic plate 58 contacts the first side 62 of the mold 64 while a second side 68 of the metallic plate 58 remains exposed. The metallic plate 58 may be any one of the metallic plates 10, 26, and 42, described above, or any variation or alteration of the metallic plates 10, 26, and 42, also described above. A pin 70 located on the first side 62 of the mold 64 may be inserted into a centrally located orifice 72 of the metallic plate 58 in order to secure the location of the metallic plate 58 relative to the first side 62 of the mold 64. An uncured-plastic material (or sheet) 74 is placed onto a second side 76 of the mold 64. The metallic plate 58 may include a centrally located offset 78 that protrudes towards the second side 68 of the metallic plate 58. The second side 68 of metallic plate 58 and the centrally located offset 78 may face the uncured-plastic material 74 and/or the second side 76 of the mold 64. The mold 64 may then be closed forcing the uncured-plastic material 74 into contact with the second side 68 of the metallic plate 58 and/or the centrally located offset 78. The uncured-plastic material 74 may permeate the at least one aperture 60 (which may consist of through holes, tapped holes, cut-outs, or notches as described above) and extend beyond an exterior perimeter (or external boundary) 80 of the metallic plate 58. Alternatively, the mold 64 may be closed with the metallic plate 58 placed onto the first side 62 of the mold and then the uncured-plastic material 74 may be injected into the mold 64 through an injection molding process. The uncured-plastic material 74 is then cured and secured to the second side 68 of the metallic plate 58. The now cured-plastic material (or sheet) 82 and the metallic plate 58 may collectively form a composite structure 84. Portions of the cured-plastic material 82 may fill the void of the at least one aperture 60, creating a mechanical interlock between the metallic plate 58 and the cured-plastic material 82. The mechanical interlock increases the torsional strength of the composite structure 84 and prevents disengagement of the metallic plate 58 from the cured-plastic material 82 when a torsional load is applied. The centrally located offset 78 of the metallic plate 58 may extend into the cured-plastic material 82 and may be exposed on a back side 86 of the composite structure 84 while the first side 66 of the metallic plate 58 may be exposed on a front side 88 of the composite structure 84.

The uncured-plastic material 74, and ultimately the cured-plastic material 82 may be made from any desirable material including thermoplastics, thermoset plastics (also known as thermoset polymers), or composite materials. Composite materials may include fiber-reinforced plastics (also known as fiber-reinforced polymers). Fiber-reinforced plastics are composite materials made of a polymer matrix reinforced with fibers. The fibers may be glass, carbon, basalt, aramid or other appropriate reinforcing materials. The polymer may be an epoxy, vinylester, polyester thermosetting plastic, phenol formaldehyde resin, or any other appropriate polymer or plastic. Fiber-reinforced plastics may also be heat and/or pressure cured.

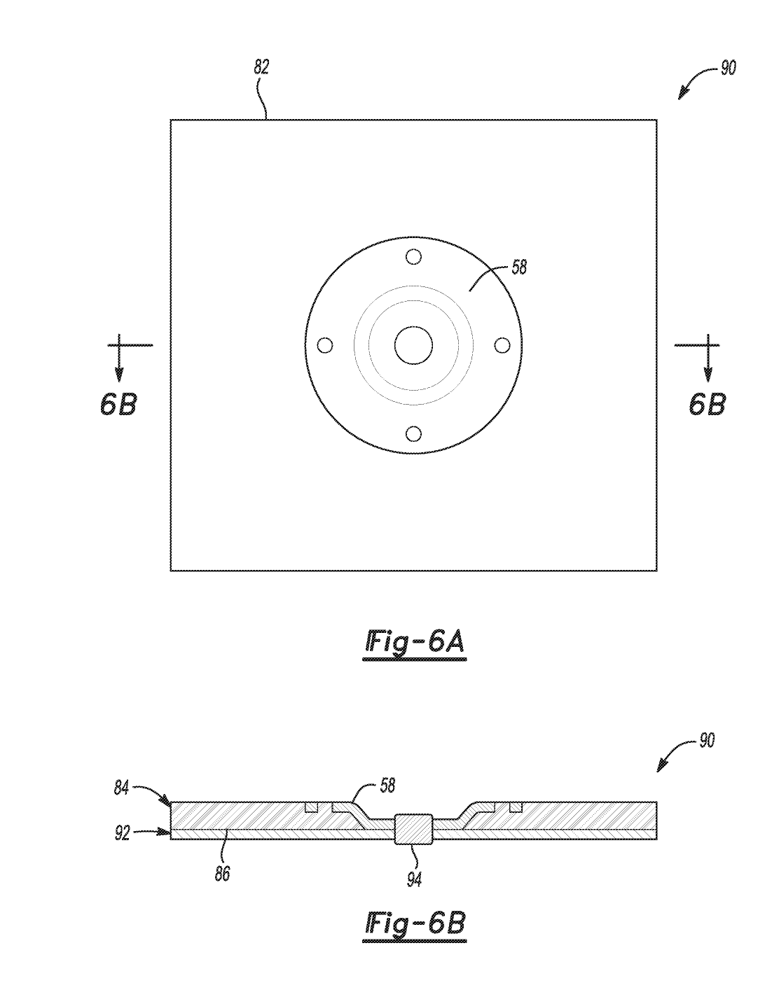

Referring to FIGS. 6A and 6B, a structural component 90 that includes the composite structure 84 formed in the mold 64 is illustrated. The structural component 90 may also be a composite structure. In addition to the composite structure 84, the structural component 90 includes a metallic sheet 92 that is disposed on an opposing side of the cured-plastic material 82 relative to the metallic plate 58. More specifically, the metallic sheet 92 may be disposed on the back side 86 of the composite structure 84. The metallic sheet 92 may directly contact the back side 86 of the composite structure 84 including the centrally located offset 78 of the metallic plate 58 that is exposed on the back side 86 of the composite structure 84. The metallic sheet 92 may be secured to the metallic plate 58. More specifically, the metallic sheet 92 may be secured to the centrally located offset 78 of the metallic plate 58. The metallic sheet 92 may secured to the metallic plate 58 by welding material 94 that is deposited during a welding process. The welding material 94 may be disposed within and extend out of the centrally located orifice 72 of the metallic plate 58. Alternatively, the metallic sheet 92 may be secured to the metallic plate 58 by fasteners, such as screws, bolts, or rivets.

The composite structure 84 alone or the structural component 90 (that includes the composite structure 84) may be used to construct various structural components of a vehicle frame or body, including longitudinally-extending members, laterally extending members (e.g., cross-members), vertically extending members, panels, etc. More specifically the composite structure 84 alone or the structural component 90 may be used to construct various components of an automobile body-in-white structure. The body-in-white structure may include roof rails, pillars (such as A-pillars, B-pillars, C-pillars, D-pillar, etc.), side rails, front rails, rear rails, rocker panels, strut towers, roof cross members, floor cross members, floor panels, roof panels, firewalls, radiator core supports, or any other component of the vehicle body-in-white structure or the frame known in the art.

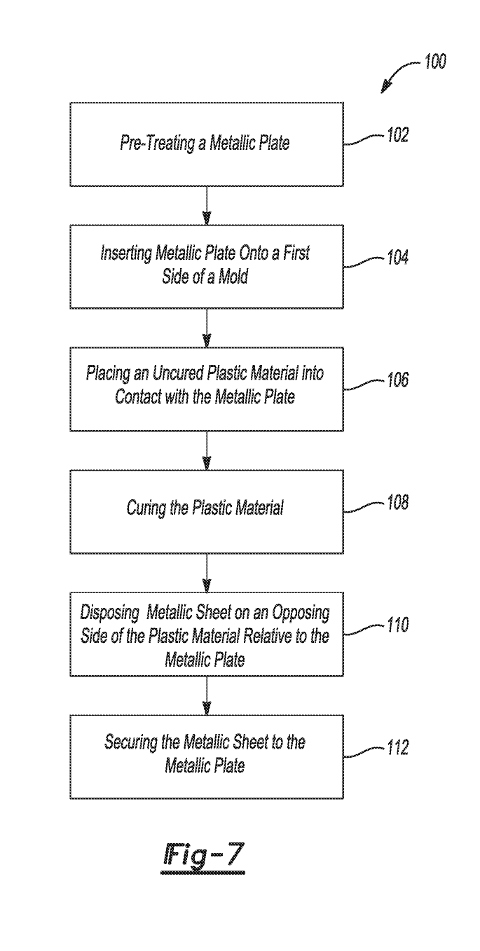

Referring to FIG. 7, a method 100 of forming the composite structure 84 and/or the structural component 90 is illustrated. The method 100 may begin at step 102 where the metallic plate 58 is pre-treated to promote adhesion between the metallic plate 58 and the uncured-plastic material 74 (and ultimately the cured-plastic material 82). The metallic plate 58 may be coated with a material that facilitates adhesion or pre-treated by a chemical process that changes the surface properties of the metallic plate to promote adhesion. The method 100 then moves on to step 104, where the metallic plate 58 is disposed on the first side 62 of the mold 64 such that the first side 66 of the metallic plate 58 contacts the first side 62 of the mold 64 while a second side 68 of the metallic plate 58 remains exposed. The uncured-plastic material 74 is then placed into contact with the second side 68 of the metallic plate 58 at step 106. The uncured-plastic material 74 may also permeate the at least one aperture 60 of the metallic plate 58 at step 106. Step 106 may be accomplished by closing the mold 64 after placing the uncured-plastic material 74 onto the second side 76 of the mold 64 while the metallic plate 58 is disposed on the first side 62 of the mold 64, as described above. Alternatively, step 106 may be accomplished by injecting the uncured-plastic material 74 into the mold 64 through an injection molding process after closing the mold 64 while the metallic plate 58 is disposed on the first side 62 of the mold 64, as described above. After placing the uncured-plastic material 74 into contact with the second side 68 of the metallic plate 58, the uncured-plastic material 74 is then cured at step 108 and transformed into the cured-plastic material 82. Once cured, portions of the cured-plastic material 82 may fill the void of the at least one aperture 60.

Once the plastic material is cured at step 108, the method 100 moves on to step 110 where the metallic sheet 92 is disposed on an opposing side of the cured-plastic material 82 relative to the metallic plate 58, as described above. The metallic sheet 92 is then secured to the metallic plate 58 (or more specifically the centrally located offset 78 of the metallic plate 58) at step 112. The metallic sheet 92 may be secured to the metallic plate 58 by a weld or a fastener, as described above. It should be understood that the flowchart in FIG. 7 is for illustrative purposes only and that the method 100 should not be construed as limited to the flowchart in FIG. 7. Some of the steps of the method 100 may be rearranged while others may be omitted entirely.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle body structural member comprising:
a metallic disk having an external perimeter and defining at least one aperture extending through a thickness of the metallic disk;
a cured-plastic sheet secured to the metallic disk, the cured-plastic sheet extending beyond the perimeter and into the at least one aperture; and
a metallic sheet disposed on an opposing side of the cured-plastic sheet relative to the metallic disk and secured to the metallic disk.

2. The member of claim 1, wherein the at least one aperture comprises at least one through hole defined by the metallic disk.

3. The member of claim 2, wherein the at least one through hole comprises a plurality of through holes that are evenly spaced relative to the perimeter.

4. The member of claim 1, wherein the at least one aperture comprises at least one notch defined by the metallic disk along the perimeter of the metallic disk.

5. The member of claim 1, wherein metallic disk includes an offset that extends into the cured-plastic sheet and the metallic sheet is secured to the offset.

6. The member of claim 5, wherein the offset is welded to the metallic sheet in order to secure the metallic sheet to the metallic disk.

7. The member of claim 1, wherein the metallic disk includes a centrally located orifice.

8. The member of claim 7, wherein welding material disposed within and extending out of the centrally located orifice secures the metallic sheet to the metallic disk.

9. The member of claim 1, wherein the cured-plastic sheet is a fiber-reinforced plastic composite material.

10. A composite structure comprising:
a metallic plate having and an external boundary and a centrally located offset protruding towards a first side, the metallic plate defining at least one aperture extending through a thickness of the metallic plate; and
a cured-plastic sheet secured to the first side of the metallic plate, the cured-plastic sheet extending beyond the boundary and into the at least one aperture.

11. The composite structure of claim 10, further comprising a metallic sheet disposed on an opposing side of the cured-plastic sheet relative to the metallic plate and secured to the centrally located offset of the metallic plate.

12. The composite structure of claim 11, wherein the offset is welded to the metallic sheet in order to secure the metallic sheet to the metallic plate.

13. The composite structure of claim 10, wherein the at least one aperture comprises at least one through hole defined by the metallic plate.

14. The composite structure of claim 10, wherein the at least one aperture comprises at least one notch defined by the metallic plate along the boundary of the metallic plate.

15. The composite structure of claim 14, wherein the at least one notch comprises a plurality of notches that are evenly spaced relative to the boundary.

16. A method comprising:
inserting a metal plate that defines at least one aperture into a first side of a mold such that a first side of the metal plate contacts the mold while a second side of the metal plate remains exposed;
placing an uncured-plastic material into contact with the second side of the metal plate such that the plastic material permeates the at least one aperture; and
curing the plastic material.

17. The method of claim 16, further comprising:
upon completion of curing the plastic material,
disposing a metallic sheet on an opposing side of the plastic material relative to the metal plate, and
welding the metallic sheet to an offset of the metal plate that extends into the plastic material.

18. The method of claim 16, further comprising pre-treating the metal plate to promote adhesion with the plastic material.

19. The method of claim 16, wherein the uncured-plastic material is placed into contract with the second side of the metal plate via injection molding.

20. The method of claim 16, wherein the uncured-plastic material is inserted into a second side of the mold, and wherein the uncured-plastic material is placed into contact with the second side of the metal plate by closing the mold.
